(19) United States
(12) Patent Application Publication
(10) Pub. No.: US 2022/0245917 A1
(43) Pub. Date: Aug. 4, 2022

(54) SYSTEMS AND METHODS FOR NEAREST-NEIGHBOR PREDICTION BASED MACHINE LEARNED MODELS

(71) Applicant: Google LLC, Mountain View, CA (US)

(72) Inventors: Byungha Chun, Tokyo (JP); Hideto Kazawa, Tokyo (JP); Jun Suzuki, Miyagi (JP); Yusuke Oda, Shiki-Shi (JP)

(21) Appl. No.: 17/559,633

(22) Filed: Dec. 22, 2021

Related U.S. Application Data
(60) Provisional application No. 63/145,835, filed on Feb. 4, 2021.

(51) Int. Cl. G06V 10/22; G06V 10/82; G06V 10/774; G06F 40/284

(52) U.S. Cl. CPC G06V 10/23; G06F 40/284; G06V 10/774; G06V 10/82

(57) ABSTRACT

Systems and methods of the present disclosure can include a computer-implemented method. The method can include obtaining a machine-learned model comprising one or more layers. At least a first layer of the one or more layers can be configured to receive a set of query vectors respectively associated with layer inputs, determine similarity measures the key vectors and the query vectors, apply a normalization operation to the plurality of respective similarity measures, and determine an output based on the normalized respective similarity measures and a plurality of class labels respectively associated with the plurality of key vectors.

### RELATED APPLICATIONS

This application claims priority to and the benefit of U.S. Provisional Patent Application No. 63/145,835, filed Feb. 4, 2021. U.S. Provisional Patent Application No. 63/145,835 is hereby incorporated by reference in its entirety.

### FIELD

The present disclosure relates generally to implementation of nearest neighbor prediction in machine-learned models. More particularly, the present disclosure relates to the utilization of k-nearest neighbor prediction in conjunction with attention mechanisms one or more layers of machine-learned models.

### BACKGROUND

Nearest-neighbor-based prediction for machine-learned models (e.g., deep neural networks, etc.) has gradually gained attention in the field of artificial intelligence. An advantage of nearest-neighbor-based prediction is that training samples can also work as secondary information for prediction (e.g., whether a prediction can be trusted, etc.). This can be particularly beneficial for real-world systems, since predictions provided by machine-learned models are generally imperfect, and the internal operations of certain prediction models (e.g., deep neural networks, etc.) are relatively obscured.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system can include one or more processors. The computing system can include one or more tangible, non-transitory computer readable media storing a machine-learned model comprising one or more layers. At least a first layer of the one or more layers can be configured to receive a set of one or more query vectors respectively associated with one or more layer inputs. At least a first layer of the one or more layers can be configured to determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes. At least a first layer of the one or more layers can be configured to apply a normalization operation to the plurality of respective similarity measures. At least a first layer of the one or more layers can be configured to determine an output based on the normalized respective similarity measures and a plurality of class labels respectively associated with the plurality of key vectors.

Another example aspect of the present disclosure is directed to a computer-implemented method. The method can include obtaining, by a computing system comprising one or more computing devices, a machine-learned model comprising one or more layers. At least a first layer of the one or more layers can be configured to receive a set of one or more query vectors respectively associated with one or more layer inputs. At least a first layer of the one or more layers can be configured to determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes. At least a first layer of the one or more layers can be configured to apply a normalization operation to the plurality of respective similarity measures. At least a first layer of the one or more layers can be configured to determine an output based on the normalized respective similarity measures and a plurality of class labels respectively associated with the plurality of key vectors. The method can include processing, by the computing system, one or more model inputs with the machine-learned model to obtain a model output.

Another example aspect of the present disclosure is directed to one or more tangible, non-transitory computer readable media storing a machine-learned model comprising one or more layers. At least a first layer of the one or more layers can be configured to receive a set of one or more query vectors respectively associated with one or more layer inputs. At least a first layer of the one or more layers can be configured to determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes. At least a first layer of the one or more layers can be configured to apply a normalization operation to the plurality of respective similarity measures. At least a first layer of the one or more layers can be configured to determine an output based on the normalized respective similarity measures and a plurality of class labels respectively associated with the plurality of key vectors.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs machine-learning tasks using at least one unified layer according to example embodiments of the present disclosure.

FIG. 1B depicts a block diagram of an example computing device that performs machine-learning tasks using at least one unified layer according to example embodiments of the present disclosure.

FIG. 1C depicts a block diagram of an example computing device that performs machine-learning tasks using a unified layer according to example embodiments of the present disclosure.

FIG. 2 depicts a dataflow diagram for an example layer of a machine-learned model according to example embodiments of the present disclosure.

FIG. 3 depicts a flow chart diagram of an example machine-learned model layer according to example embodiments of the present disclosure.

Reference numerals that are repeated across plural figures are intended to identify the same features in various implementations.

### DETAILED DESCRIPTION

### Overview

Generally, the present disclosure is directed to the utilization of k-nearest neighbor techniques for one or more layers of attention-based model such as, for example, a transformer model or other model that includes one or more self-attention layers (e.g., multi-headed self-attention layers). As an example, the final layer of some deep neural network models (e.g., transformer models, etc.) generally utilizes a softmax activation function for calculation of probability distributions over output classes. Replacement of this softmax activation function with nearest neighbor prediction operations can lead to increased performance, but may also lead to increased computational costs. However, the implementation of this softmax activation function in a layer of a model (e.g., a hidden layer and/or the final output layer) alongside nearest-neighbor prediction operations can both substantially increase classification performance while also reducing overall computational costs required for model processing.

As an example, a machine-learned model (e.g., an attention-based model such as a transformer model, etc.) can include one or more layers. At least one of these layers can facilitate nearest neighbor based prediction. For example, the layer can be configured to receive a set of one or more query vectors that are respectively associated with one or more query inputs (e.g., two query vectors associated with two input images, query vector(s) associated with tabular data, etc.). The layer can be configured to then determine a plurality of similarity measures between a respective plurality of key vectors and the one or more query vectors. To assist integration of nearest neighbor prediction, one or more of the key vectors can include one or more hidden state vectors that are respectively associated with one or more training examples included in a dataset associated with the machine-learned model (e.g., used to train the model, etc.). Additionally, one or more of the plurality of key vectors can respectively include one or more learned class embeddings. These learned class embeddings can be respectively associated with one or more classes of a plurality of classes. As an example, the query vector(s) can be associated with input image(s), the training dataset can include training image(s), and the classes can include a plurality of image class classifications.

To follow the previous example, the layer can be configured to apply a normalization operation to the plurality of respective similarity measures. Additionally, the layer can be configured to determine an output based on the normalized respective similarity measures and a plurality of class labels respectively associated with the plurality of key vectors. In such fashion, certain model architectures (e.g., transformer models, etc.), can integrate nearest-neighbor prediction in processing operations, therefore reducing computational costs and increasing accuracy when compared to conventional architectures (e.g., softmax-based transformer architectures, etc.).

The systems and methods described herein provide a number of technical effects and benefits. As one example, by formulating a model layer (e.g., a hidden layer and/or an output layer) that leverages both softmax activation and nearest neighbor prediction, the systems and methods of the present disclosure can substantially increase the performance (e.g., predictive accuracy) of various models (e.g., classification models), therefore leading to increased system performance and a substantial reduction in computational costs associated with an incorrect model output (e.g., less processing power, less memory usage, less power consumption, etc.). Additionally, by utilizing both softmax activation alongside nearest neighbor prediction, the systems and methods of the present disclosure can substantially reduce the computational costs associated with general implementation of nearest neighbor prediction methods, therefore allowing for an optimal ratio of computational expense to overall system performance.

With reference now to the Figures, example embodiments of the present disclosure will be discussed in further detail.

### Example Devices and Systems

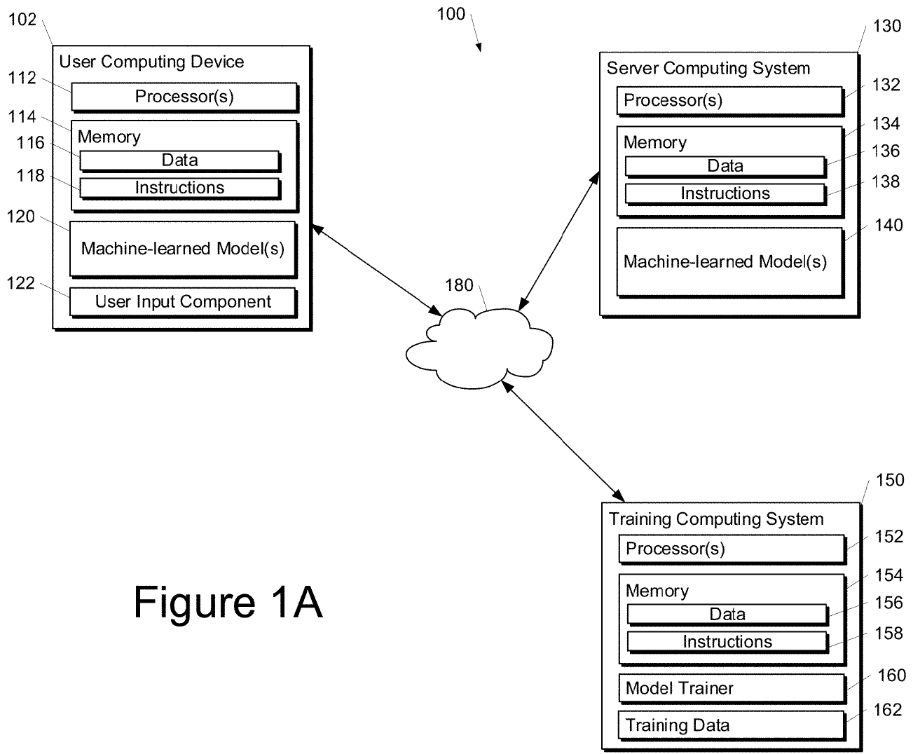

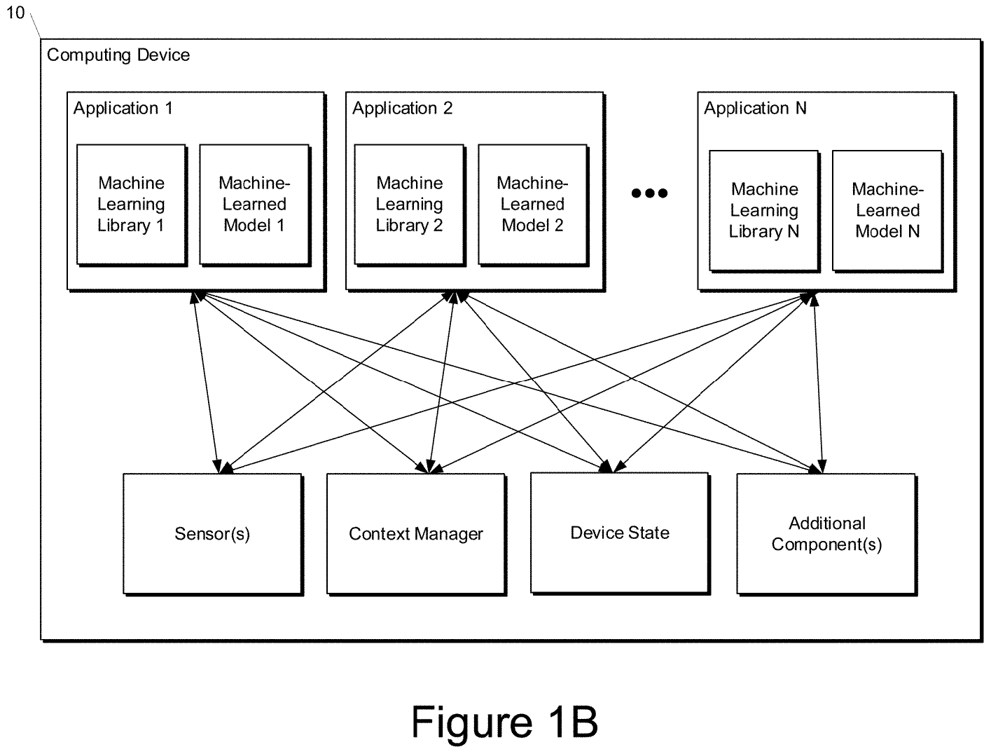

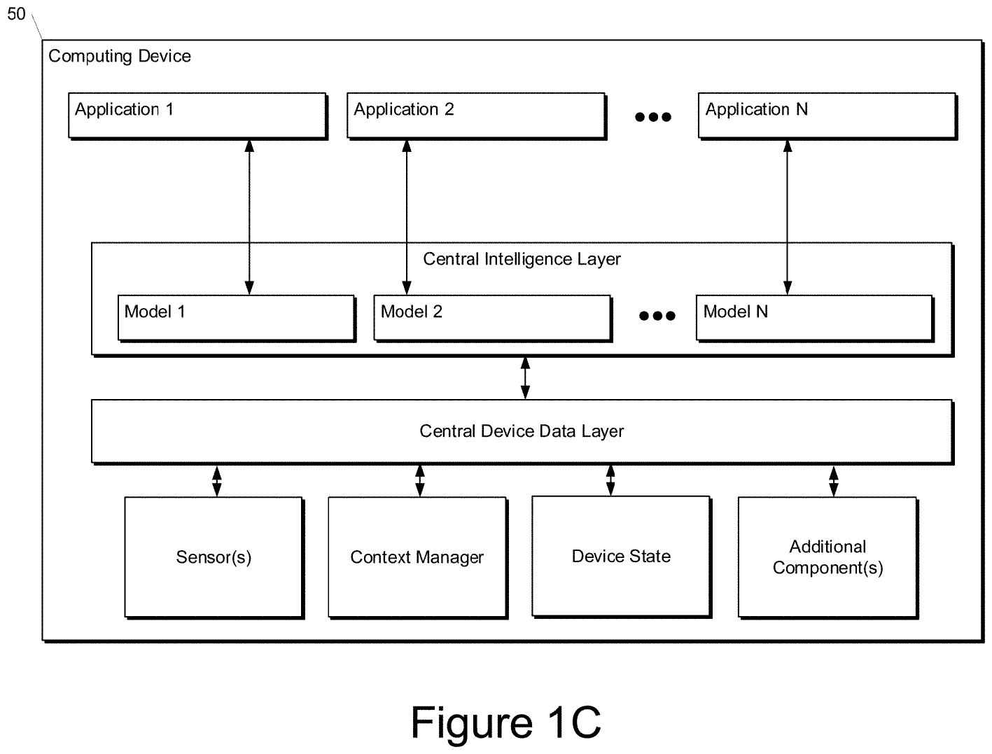

FIG. 1A depicts a block diagram of an example computing system 100 that performs machine-learning tasks using at least one unified layer according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

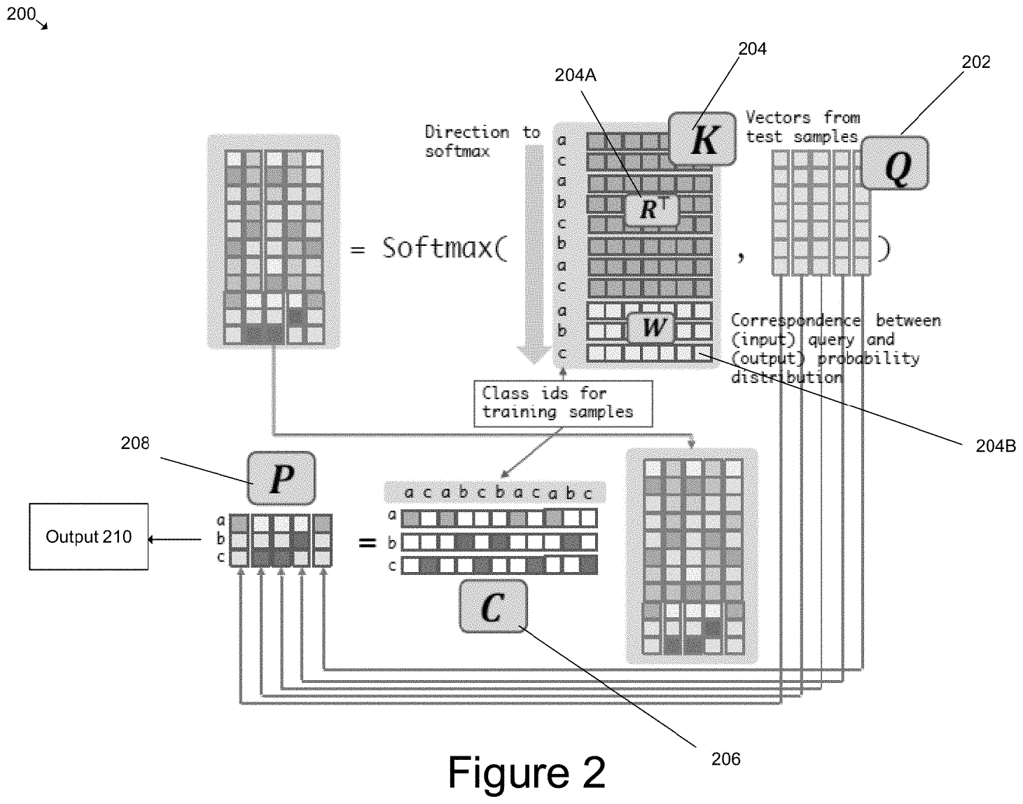

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIG. 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel classification across multiple instances of the machine-learned model).

More particularly, the machine-learned model 120 can include one or more layers. At least one of these layers can facilitate nearest neighbor based prediction. For example, the layer can be configured to receive a set of one or more query vectors that are respectively associated with one or more query inputs (e.g., two query vectors associated with two input images, etc.). The layer can be configured to then determine a plurality of similarity measures between a respective plurality of key vectors and the one or more query vectors. To assist integration of nearest neighbor prediction, one or more of the key vectors can include one or more hidden state vectors that are respectively associated with one or more training examples included in a dataset associated with the machine-learned model 120 (e.g., used to train the model 120, etc.). Additionally, one or more of the plurality of key vectors can respectively include one or more learned class embeddings. These learned class embeddings can be respectively associated with one or more classes of a plurality of classes. As an example, the query vector(s) can be associated with input image(s), the training dataset can include training image(s), and the classes can include a plurality of image class classifications. To follow the previous example, the layer can be configured to apply a normalization operation to the plurality of respective similarity measures. Additionally, the layer can be configured to determine an output based on the normalized respective similarity measures and a plurality of class labels respectively associated with the plurality of key vectors

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a classification service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, data to facilitate training of a classification model (e.g., image data, statistical data, etc.).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g. one or more image or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs machine-learning tasks using at least one unified layer according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs machine-learning tasks using a unified layer according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a dataflow diagram for an example layer 200 of a machine-learned model according to example embodiments of the present disclosure. As an example, the layer 200 can be a final output layer for a deep learning neural network (e.g., a transformer model, etc.). More particularly, the layer 200 can receive a set of one or more query vectors 202. The one or more query vectors 202 can be associated with one or more layer inputs to the layer 200. For example, a previous layer of the model can process the one or more inputs (e.g., images, etc.) to generate the one or more query vectors 202.

Additionally, the layer can include a plurality of key vectors 204. The key vectors 204 can include one or more hidden state vectors 204A that are respectively associated with one or more training examples included in a training dataset associated with the model. For example, the model can be previously trained utilizing one or more training images for image classification tasks. The one or more hidden state vectors 204A can respectively correspond to the one or more training images used to train the model for image classification. The key vectors 204 can additionally include one or more learned class embeddings 204B. The learned class embedding(s) 204B can represent or otherwise be associated with one or more classes of a plurality of classes. To follow the previous example, the one or more class embeddings 204B can be learned class embeddings 204B that correspond to classification of the one or more training images that were learned during training for image classification tasks.

The layer 200 can determine a plurality of similarity measures 208 between the respective plurality of key vectors 204 and the set of one or more query vectors 202. The layer 200 can apply a normalization function to the plurality of similarity measures 208 (e.g., a softmax normalization function, etc.). After normalization of the similarity measures 208, the layer 200 can determine an output 210 based on the normalized respective similarity measures and the plurality of class labels 206 respectively associated with the plurality of key vectors 204. In such fashion, nearest neighbor prediction can be leveraged in a key-value-query formulation, therefore enabling nearest neighbor prediction in the layer while reducing computational resource costs.

### Example Methods

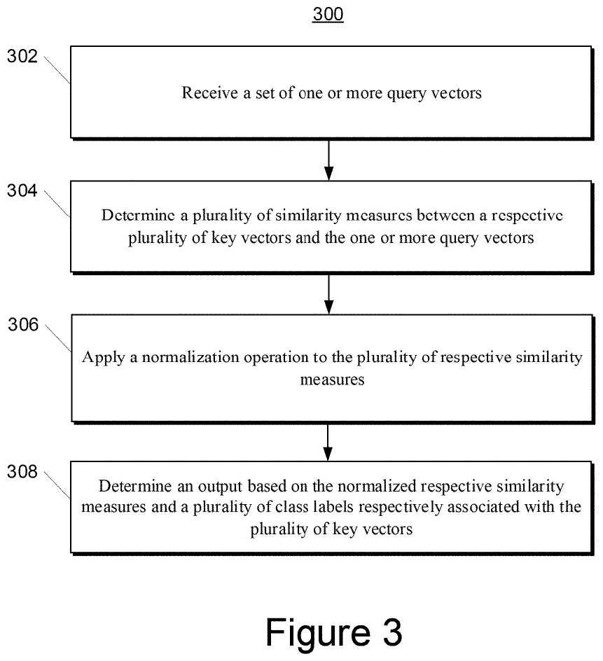

FIG. 3 depicts a flow chart diagram of an example machine-learned model layer 300 according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a machine-learned model layer can be configured to receive a set of one or more query vectors. More particularly, the layer can be configured to receive a set of one or more query vectors respectively associated with one or more layer inputs (e.g., one or more images, one or more datasets, etc.).

At 304, the machine-learned model layer can be configured to determine a plurality of similarity measures between a respective plurality of key vectors and the one or more query vectors. More particularly, the one or more of the plurality of key vectors can include one or more hidden state vectors respectively associated with one or more training examples included in a training dataset associated with the machine-learned model. Additionally, one or more of the plurality of key vectors can respectively include one or more learned class embeddings respectively associated with one or more classes of a plurality of classes.

At 306, the machine-learned model layer can be configured to apply a normalization operation to the plurality of respective similarity measures (e.g., a softmax normalization function, etc.).

At 308, the machine-learned model layer can be configured to determine an output based on the normalized respective similarity measures and a plurality of class labels respectively associated with the plurality of key vectors (e.g., an image classification output, a natural language processing output, etc.).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, comprising:
one or more processors;
one or more tangible, non-transitory computer readable media storing a machine-learned model comprising one or more layers, wherein at least a first layer of the one or more layers is configured to:
receive a set of one or more query vectors respectively associated with one or more layer inputs;
determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes;
apply a normalization operation to the plurality of respective similarity measures; and
determine an output based on the normalized respective similarity measures and a plurality of class labels respectively associated with the plurality of key vectors.

2. The computing system of claim 1, wherein the plurality of classes comprise a plurality of tokens associated with a natural language.

3. The computing system of claim 1, wherein the machine-learned model comprises a transformer model.

4. The computing system of claim 1, wherein the first layer comprises a final classification layer.

5. The computing system of claim 1, wherein the first layer comprises an intermediate layer.

6. The computing system of claim 1, wherein the one or more hidden state vectors respectively associated with the one or more training examples comprise one or more trained prototype vectors.

7. The computing system of claim 1, wherein the plurality of similarity measures comprises at least one of:
cosine similarity;
scaled cosine similarity;
trainable vector similarity;
centroid vector similarity;
one-sided scaled cosine similarity; or dot product similarity.

8. The computing system of claim 1, wherein receiving a set of one or more query vectors comprises generating the one or more query vectors based at least in part on the one or more layer inputs and a set of learned weights.

9. The computing system of claim 8, wherein the at least the first layer is further configured to generate a model output based at least in part on the output of the at least the first layer.

10. The computing system of claim 9, wherein the one or more tangible, non-transitory computer readable media further store instructions that, when executed by one or more processors of a computing system, cause the computing system to perform operations, the operations comprising:
processing one or more inputs with the machine-learned model to obtain the model output; and
evaluating a loss based at least in part on the model output.

11. The computing system of claim 1, wherein the operations further comprise modifying the set of learned weights based at least in part on the loss.

12. The computing system of claim 10, wherein the operations further comprise modifying at least one of the one or more learned class embeddings based at least in part on the loss.

13. A computer-implemented method, comprising:
obtaining, by a computing system comprising one or more computing devices, a machine-learned model comprising one or more layers, wherein at least a first layer of the one or more layers is configured to:
receive a set of one or more query vectors respectively associated with one or more layer inputs;
determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes;
apply a normalization operation to the plurality of respective similarity measures; and
determine an output based on the normalized respective similarity measures and a plurality of class labels respectively associated with the plurality of key vectors; and
processing, by the computing system, one or more model inputs with the machine-learned model to obtain a model output.

14. The computer-implemented method of claim 13, wherein the plurality of classes comprise a plurality of tokens associated with a natural language.

15. The computer-implemented method of claim 13, wherein the machine-learned model comprises a transformer model.

16. The computer-implemented method of claim 13, wherein the first layer comprises a final classification layer.

17. The computer-implemented method of claim 13, wherein the first layer comprises an intermediate layer.

18. The computer-implemented method of claim 13, wherein the method further comprises:
evaluating, by the computing system, a loss based at least in part on the model output;
modifying, by the computing system, a set of learned weights based at least in part on the loss; and
modifying, by the computing system, at least one of the one or more learned class embeddings based at least in part on the loss.

19. The computer-implemented method of claim 13, wherein the plurality of similarity measures comprises at least one of:
cosine similarity;
scaled cosine similarity;
trainable vector similarity;
centroid vector similarity;
one-sided scaled cosine similarity; or
dot product similarity.

20. One or more tangible, non-transitory computer readable media storing a machine-learned model comprising one or more layers, wherein at least a first layer of the one or more layers is configured to:
receive a set of one or more query vectors respectively associated with one or more layer inputs;
determine a plurality of similarity measures between a respective plurality of key vectors and the one or more query vectors, wherein one or more of the plurality of key vectors comprise one or more hidden state vectors respectively associated with one or more training examples included in a training dataset associated with the machine-learned model, and wherein one or more of the plurality of key vectors respectively comprise one or more learned class embeddings respectively associated with one or more classes of a plurality of classes;
apply a normalization operation to the plurality of respective similarity measures;
determine an output based on the normalized respective similarity measures and a plurality of class labels respectively associated with the plurality of key vectors;
evaluate a loss function to determine a loss value based at least in part on a model output that is a function of the output; and
update one or more parameters of the machine-learned model based at least in part on the loss value.
